(19) United States
(12) Patent Application Publication
(10) Pub. No.: US 2025/0193610 A1
(43) Pub. Date: Jun. 12, 2025

(54) METHOD OF OPERATING A BINAURAL HEARING INSTRUMENT AND BINAURAL HEARING INSTRUMENT

(71) Applicant: Sivantos Pte. Ltd., Singapore (SG)

(72) Inventor: Eghart FISCHER, Erlangen (DE)

(21) Appl. No.: 18/956,925

(22) Filed: Nov. 22, 2024

(30) Foreign Application Priority Data
Dec. 6, 2023 (EP) 23 214 658.9

(51) Int. Cl. H04R 25/00

(52) U.S. Cl. CPC H04R 25/407; H04R 25/505

(57) ABSTRACT

A method operates a binaural hearing instrument which has two signal-coupled individual hearing devices. In each hearing device, a first input signal is generated from a sound signal by a first input transducer. A second input signal is generated from a sound signal by a second input transducer. Forward and backward signals are generated from the first and second input signals. A first adaptation parameter is determined as a linear factor of a linear combination of the forward and backward signals, and a first directional signal resulting from this linear combination has one-directional attenuation. The adaptation parameter is compared with a stored threshold value. If at least one of the adaptation parameters falls below the threshold value, the adaptation parameters of the individual hearing devices are synchronized with one another. A second directional signal is generated in each case based on the synchronized adaptation parameters for generating an output signal.

### CROSS-REFERENCE TO RELATED APPLICATION

This application claims the priority, under 35 U.S.C. § 119, of European Patent Application EP 23 214 658.9, filed Dec. 6, 2023; the prior application is herewith incorporated by reference in its entirety.

### FIELD AND BACKGROUND OF THE INVENTION

The invention relates to a method for operating a binaural hearing instrument which has two signal-coupled individual hearing devices. In particular, the method relates to directional signal processing in a binaural hearing instrument. The invention further relates to a binaural hearing instrument for carrying out the method.

The term “hearing instrument” generally refers to an electronic device that supports the hearing ability of a person wearing the hearing instrument. In particular, the invention relates to a hearing instrument that is designed to compensate for all or part of the hearing loss of a hearing-impaired user. Such a hearing instrument is also referred to as a “hearing aid” (HA). In addition, there are hearing instruments that protect or improve the hearing ability of normal-hearing users, for example, to enable improved speech understanding in complex listening situations. Such devices are also called “Personal Sound Amplification Products” (PSAP for short). Finally, the term “hearing instrument” in the sense used here also includes headphones worn on or in the ear (wired or wireless and with or without active noise suppression), headsets, etc., as well as implantable hearing instruments, such as cochlear implants.

Hearing instruments in general, and hearing aids in particular, are usually configured to be worn on the head and here in particular in or on one ear of the user, especially as behind-the-ear (BTE) or in-the-ear (ITE) devices. Regarding their internal structure, hearing instruments regularly have at least one output transducer that converts an output audio signal supplied for the purpose of output into a signal that can be perceived by the user as sound, and outputs the latter to the user.

In most cases, the output transducer is configured as an electro-acoustic transducer that converts the (electrical) output audio signal into an airborne sound, whereby this output airborne sound is emitted into the user's ear canal. In a hearing instrument worn behind the ear, the output transducer, also called the “receiver”, is usually integrated outside the ear in a housing of the hearing instrument. In this case, the sound emitted by the output transducer is guided into the user's ear canal by means of a sound tube. Alternatively, the output transducer can also be located in the ear canal, and thus outside the housing worn behind the ear. Such hearing instruments are also called RIC devices (Receiver In Channel). Hearing instruments worn in the ear, which are so small that they do not protrude outside the ear canal, are also called CIC devices (Completely in Canal).

In further designs, the output transducer can also be configured as an electro-mechanical transducer that converts the output audio signal into structure-borne sound (vibrations), whereby this structure-borne sound is emitted into the skull bone of the user, for example. There are also implantable hearing instruments, especially cochlear implants, and hearing instruments whose output transducers directly stimulate the user's auditory nerve.

In addition to the output transducer, a hearing instrument often has at least one (acousto-electric) input transducer. During operation of the hearing instrument, the or each input transducer picks up an airborne sound from the environment of the hearing instrument, and converts this airborne sound into an input audio signal (i.e. an electrical signal carrying information about the ambient sound). This input signal—also referred to as a “recorded sound signal”—is regularly output in original or processed form to the user himself, e.g. to realize a so-called transparency mode in headphones, for active noise suppression or—e.g. in a hearing aid—to achieve an improved sound perception of the user.

In addition, a hearing instrument often has a signal processing unit (signal processor). In the signal processing unit, the or each input signal is processed (i.e. modified with respect to its sound information). The signal processing unit thereby outputs an appropriately processed audio signal (also referred to as “output audio signal”, “output signal” or “modified sound signal”) to the output transducer and/or to an external device.

A hearing instrument that has two individual hearing devices working together to supply the user's two ears is also referred to as a “binaural hearing system” or “binaural hearing instrument”. In a binaural hearing instrument, two such individual hearing devices are worn by a user on different sides of the head, so that each individual hearing device is assigned to one ear, with a wireless communication link, i.e. a signaling coupling, existing between the individual hearing devices. During operation, for example, data, possibly also large amounts of data, are exchanged between the hearing device on the right and left ear. The exchanged data and information enable a particularly effective adaptation of the individual hearing devices to a respective acoustic environment. This enables a particularly authentic spatial sound for the user and improves speech comprehension, even in noisy environments.

The hearing instrument or the individual hearing devices can be designed for directional signal processing, i.e. for direction-dependent evaluation of the input signals. For this purpose, the individual hearing devices have at least two input transducers, each of which generates an input signal. The input transducers act as a differential directional microphone. The further processing within the individual hearing device by the signal processing unit includes the formation of directional signals from the input signals, whereby the different directional effect is usually used to emphasize a useful signal source-usually a speaker in the environment of the hearing instrument user—and/or to suppress background noise.

A special further development of this is the so-called adaptive differential directional microphone (ADM), in which a directional signal is generated in such a way that it has a maximum attenuation in the direction of an assumed, localizable noise source. The assumption used for this is usually that sounds occurring from the area behind the hearing instrument user, i.e. in his or her posterior hemisphere, are basically to be treated as background noise. Based on this assumption, conventional directional microphone algorithms usually minimize the signal energy from the posterior hemisphere to produce the directional signal with the desired attenuation characteristics. In the direction of maximum attenuation, the directional signal or its directional characteristic has a spatial notch, i.e. an angle of minimum sensitivity. This angle (range) or notch has preferably a total (“infinite”) attenuation or attenuation, so that the sound of the localized noise source is ideally completely faded out of the directional signal.

To generate the directional signal, the input signals of the input transducers of a single hearing device are processed with an adaptive matching or adaptation parameter. As a rule, a linear combination of the input signals (or signals derived from them) is carried out, whereby the adaptation parameter is used as a linear factor.

The adaptation parameters of an adaptive differential directional microphone basically adjust independently on the left and right ear side. In other words, the adaptation parameters of the individual hearing devices usually differ because an adjustment of the adaptation parameters in the course of directional signal processing essentially aims at minimizing the output signal, i.e. directing the notch towards a dominant noise source in the rear half-space.

When there is a dominant noise source, it is known from European patent application EP 1 773 100 A1, corresponding to U.S. Pat. No. 8,121,309, that the amount of attenuation or attenuation of this noise source is controlled and (in a sense) synchronized between the individual hearing devices by limiting the maximum allowable attenuation applied to the dominant noise source.

However, a direct synchronization of the values of the left/right adaptation parameters makes little sense for this application, as it would generally only be optimal for the side on which the dominant noise source is located, and not optimal for the other side. This could result in the notch being deflected away from another noise source by the synchronization.

If there is no dominant noise source, but a more diffuse noise situation or a transitional phase between loud and quiet surroundings, it may happen that no pronounced notch forms to the side and the resulting directional characteristic remains in the range of a so-called subcardioid. A “subcardioid” is a directional characteristic between omni(-directional) and cardioid, i.e. between circular/spherical and heart-shaped.

All directional patterns for subcardioids have their (more or less deep, depending on the adaptation parameter) notch at a directional angle of 180°. In case of different directivity parameters on the left and right sides (e.g.: close to the cardioid on one side and close to the (omni) sphere on the other side), a mislocalization of a noise source in the rear half-space may occur due to the different attenuation in 180° direction on both sides. Furthermore, in this case, different attenuation would be applied on the left and right sides for the corresponding directions of incidence, i.e. the attenuation for a source from +120° on the right side would differ from the attenuation for a source from −120°.

### SUMMARY OF THE INVENTION

The invention is based on the task of specifying a particularly suitable method for operating a binaural hearing instrument. In particular, an improved directional signal processing, especially in listening situations without a dominant noise source, is to be specified. The invention is further based on the task of specifying a particularly suitable binaural hearing instrument for carrying out the method.

Regarding the method, the task is solved with the features of the independent method claim and regarding the hearing instrument with the features of the independent hearing instrument claim in accordance with the invention. Advantageous designs and further developments are the subject of the dependent claims (subclaims).

The advantages and embodiments listed regarding the method can also be applied to the hearing instrument and vice versa. Insofar as method steps are described below, advantageous embodiments for the hearing instrument result from the fact that the hearing instrument is configured to carry out one or more of these method steps.

The conjunction “and/or” is to be understood here and in the following in such a way that the features linked by means of this conjunction can be formed both together and as alternatives to each other.

The method according to the invention is intended for the operation of a binaural hearing instrument and is suitable and configured for this purpose. The hearing instrument has two signal-technically coupled individual hearing devices.

According to the method, a first input signal is generated from a sound signal of the environment by a first input transducer and a second input signal is generated by a second input transducer in each of the two individual hearing devices. Each individual hearing device thus has at least two input transducers which generate a first and second input signal.

A forward signal and a backward signal (reverse signal) are then generated in the individual hearing devices from the two input signals.

The forward and backward signals are processed in the individual hearing devices to form a first directional signal, whereby the first directional signal or its directional effect is attenuated in at least one (spatial) direction or in an angular range. The first directional signal is therefore not an omnidirectional (spherical) signal but has a nontrivial directional characteristic. For this purpose, the forward and backward signals are processed by means of a linear combination, whereby an adaptation parameter (adjustment parameter) is determined as a linear factor. For example, for the first directional signal, the sum of the forward signal and a backward signal multiplied by the adaptation parameter is formed.

According to the invention, the determined adaptation parameters are each compared with a stored threshold value, whereby the same threshold value is stored in both individual hearing devices. In other words, both adaptation parameters are compared with the same threshold value in each individual hearing device. If at least one of the adaptation parameters falls below the threshold value, the adaptation parameters of the individual hearing devices are synchronized with each other, i.e. tuned or aligned. For this purpose, corresponding information and data are exchanged via the signaling coupling of the individual hearing devices, so that the same synchronized adaptation parameter is available in both individual hearing devices after synchronization.

Subsequently, a second directional signal is generated in each of the individual hearing devices using the synchronized adaptation parameter. For this purpose, the forward and backward signals are linked or processed by means of the synchronized adaptation parameter. The individual hearing devices each generate an output signal based on the second directional signals, which is preferably converted into an output sound signal via a respective output converter of the individual hearing devices. Thus, a particularly suitable method for operating a binaural hearing instrument is realized. In particular, the synchronization of the adaptation parameters enables a particularly advantageous directional signal processing for the binaural hearing instrument.

In the binaural hearing instrument, the two individual hearing devices are worn by the user on different sides of the head so that each individual hearing device is assigned to one ear. The individual hearing devices are preferably configured as hearing aids, for example, which have at least two input transducers and at least one output transducer and are thus configured to pick up sound signals from the environment and output them to a user of the hearing instrument. In addition, each of the individual hearing devices has a wireless interface for signal or data exchange between the two individual hearing devices. The wireless interface is configured, for example, as a Bluetooth or induction transceiver.

In this context, an input transducer means in particular an electro-acoustic transducer, such as a microphone, which is intended and set up to generate a corresponding electrical signal from a sound signal. The input signals are thus in particular electrical (audio) signals. Preferably, during the generation of the first or second input signal by the respective input converter, signal preprocessing is also carried out, for example in the form of (linear) preamplification and/or analogue-to-digital conversion (A/D conversion). The first and second input converters of the individual hearing devices are configured in particular as directional microphones and are interconnected accordingly.

When generating the forward signal or the backward signal from the first and the second input signal, the signal components of the first and the second input signal are preferably included in the forward or backward signal, respectively. In particular, the first and the second input signal are not both used simultaneously only for a generation of control parameters or the like which are applied to signal components of other signals. Preferably, at least the signal components of the first input signal, and particularly preferably also the signal components of the second input signal, enter linearly into the forward signal or into the backward signal. The same applies to the generation of the second directional signal on the basis of the forward signal and the backward signal, as well as possibly for other signals and their corresponding generation.

The generation of a signal, such as the second directional signal, can also be carried out from the generating signals (e.g., the forward signal and the backward signal) in such a way that one or more intermediate signals are first formed from the generating signals within the framework of the signal processing, from which the generated signal (e.g., the second directional signal) is then determined. The signal components of the generating signals, i.e., in the present example the forward and backward signals, are then first incorporated into the respective intermediate signal, and the signal components of the respective intermediate signal are then incorporated into the generated signal, i.e. in the present case into the second directional signal, so that the signal components of the generating signals (i.e. e.g. the forward signal and the second directional signal) are then determined. The signal components of the respective intermediate signal then enter the generated signal, i.e. in this case the second directional signal, so that the signal components of the generating signals (e.g. the forward signal and the backward signal) are “passed through” via the respective intermediate signal to the generated signal (i.e. e.g. the second directional signal) and, if necessary, are amplified (attenuated) frequency band by frequency band and/or are partially (time) delayed against each other and/or are weighted differently to each other, etc.

A “directional signal” is understood here and in the following to mean in particular an electrical (audio) signal that is generated by selectively detecting sound waves from a certain direction. The directional signal thus has a certain directional characteristic or directionality. This means that the directional signal has an angular dependency, so that acoustic signals are detected or captured unevenly over the solid angle. For example, the directional signal has a directional characteristic in the form of a heart or a kidney (cardioid) or a supercardioid.

A “forward signal” is understood here and in the following to be in particular a directional signal with a non-trivial directional characteristic, which in a front half-space (front hemisphere) of the respective individual hearing device has on average a higher sensitivity to a standardized test sound of a predetermined level than in a rear half-space (rear hemisphere). Preferably, the direction of maximum sensitivity of the forward signal also lies in the front hemisphere, in particular in the forward direction (i.e. at 0° with respect to a preferred direction of the individual hearing device), while a direction of minimum sensitivity of the forward signal lies in the rear hemisphere, in particular in the rearward direction (i.e. at 180° with respect to a forward direction of the individual hearing device). Preferably, the same applies mutatis mutandis to the backward signal, with the front and rear half-spaces and the forward and backward directions being interchanged. The front and rear half-space as well as the forward and backward direction of the individual hearing devices are preferably defined by a respective preferred direction of the individual hearing device, which preferably essentially coincides with the frontal or viewing direction of the user when the binaural hearing instrument is worn as intended. Deviations due to inaccurate adjustment during wearing should remain unaffected.

In particular, the forward and the backward signal are symmetrical to each other with respect to a symmetry plane perpendicular to the preferred direction. For example, the directional characteristic of the forward signal is given by a cardioid, while the directional characteristic of the backward signal is given correspondingly by an anti-cardioid.

To determine the adaptation parameters, it is not necessary that the first directional signals are actually generated for further signal processing of its signal components. Rather, for example by means of a minimization of the signal energy of the linear combination Z1+a×Z2 (with Z1 as forward signal and Z2 as backward signal) or by other methods of optimization or adaptive directional microphony, the adaptation parameter (a) can be determined without the signal resulting from the linear combination, which corresponds to the first directional signal, being subject to further use in the course of the further procedure. In this case, the second directional signal is generated directly from the forward signal and the backward signal. The adaptation parameter is adjusted or set by said minimization of the signal energy or by other methods of optimization in such a way that the resulting first directional signal, even if it has no further use, has the attenuation in a direction as required.

Here and in the following, “synchronizing” or a “synchronization” of the adaptation parameters means in particular an adjustment or adaptation of the adaptation parameter setting between the individual hearing devices, so that the adaptation parameters after synchronization, i.e. the synchronized adaptation parameters, have the same parameter value in the left and right individual hearing device.

The output signal is in particular an electrical audio signal which is output by means of an output transducer, in particular an electro-acoustic output transducer, such as a loudspeaker, as an output sound signal from the individual hearing device to the user.

In an expedient further development, the second directional signals are generated by a linear combination of the respective forward signals and backward signals with the synchronized adaptation parameter as a linear factor. For example, the sum of the forward signal and a backward signal multiplied by the synchronized adaptation parameter is formed for the second directional signal.

In a suitable embodiment, the adaptation parameters of the individual hearing devices are synchronized with each other if both adaptation parameters fall below the threshold value. Since the adaptation parameter essentially determines the shape or form of the first directional signal, i.e. its directional characteristic, the threshold value comparison essentially corresponds to a check whether a certain directional characteristic is present, i.e. whether a certain hearing or noise situation is present with the received input signals. The fact that synchronization is only carried out if both adaptation parameters fall below the threshold value ensures that the adaptation parameters are only synchronized if essentially the same hearing or noise situation is present for both individual hearing devices, i.e. if the directional characteristics are already similar to each other.

In a preferred embodiment, the threshold characterizes a subcardioid range, i.e. a parameter range in which a subcardioid directional characteristic of the first directional signals is present. The synchronization of the adaptation parameters on the left and right side offers for the subcardioid range both an optimal attenuation of interferers for the directional case (between ‘eight’ and cardioid directional characteristics) and at the same time an improved spatial perception and localization for the subcardioid range (between cardioid and (omni) sphere) compared to non-synchronized adaptation parameters.

By synchronizing the adaptation parameters only for the subcardioid range between the left and right individual hearing device, the kind of mislocalization mentioned at the beginning is avoided. The attenuation to the rear half-space (=depth of the notch) would then be the same for both ears, and a noise source from 180° would be correctly perceived in the center of the sound field. In addition, all surrounding noise sources from the rear half-space would be attenuated symmetrically, so that the direction of arrival (DOA) dependent attenuation becomes symmetrical for the left and right single unit, which is advantageous for a natural spatial perception.

In a suitable dimensioning, the adaptation parameters have a value range between −1 and 2. An adaptation parameter value of −1 corresponds to an omnidirectional (spherical) directional characteristic, where 0 corresponds to a cardioid or cardioid (notch at) 180° directional characteristic. A directivity parameter of 0.33 is a so-called supercardioid directivity (notch at) 125° and 0.5 is a hypercardioid directivity (notch at) 109°. With an adaptation parameter of 1, the resulting directional signal has an eight-shaped directional characteristic (notch at) 90° and with 2 a directional characteristic with notch at 70°. The value range between −1 and 0 is the subcardioid range. Accordingly, 0 is preferably used as the threshold value, so that a subcardioid directional characteristic is given or ensured if the value falls below the threshold value.

In one conceivable embodiment, a maximum or minimum value is used as the synchronization mechanism. In other words, a maximum or minimum value of the adaptation parameters is used to synchronize the adaptation parameters. Thus, the maximum or minimum adaptation parameter is used as the synchronized adaptation parameter for both individual hearing devices. The maximum adaptation parameter is preferably used if an overall more residual directivity is desired than using the minimum adaptation parameter, since the directivity strength of effect (SoEff) is higher for higher adaptation parameters.

In an alternative, equally conceivable version, the synchronization mechanism is based on a weighting of the left and right adaptation parameters depending on the signal levels on both sides. For synchronization, the adaptation parameters are evaluated as a function of a respective signal level of the first directional signals. Thus, a signal level is determined for the first directional signals and the adaptation parameters are weighted for synchronization based on this level. Expressed in a formula a synchronization by using a weighted combination of local and remote adaptation parameters is e.g.:

a_final=(a_local×w_local)+(a_remote×(1-w_local)), a)

wherein w_local determines the weight for the local adaptation parameter. The adaptation parameter of the respective hearing device is denoted as a_local, while a_remote refers to the adaptation parameter of the other hearing device, and a_final is the synchronized value.

In case of equal levels on both sides w_local is 0.5:

a_final=(a_local×0.5)+(a_remote×(0.5)), a)

which results in the mean value between both sides.

If the local level is louder, w_local approaches 1. This means that a_final approaches a_local on the louder side and a_remote on the other side, because on this side the remote level is louder, meaning w_local goes towards 0. As a result the adaptation parameters are still synced but in extreme cases, the pure values of the louder side are used for both sides.

In a preferred embodiment, the forward signals are each generated on the basis of a time-delayed superimposition of the respective first input signal with the respective second input signal implemented by means of a first delay parameter, and/or the backward signals are each generated on the basis of a time-delayed superimposition of the respective second input signal with the respective first input signal implemented by means of a second delay parameter. In particular, the first and the second delay parameter can be selected identically to each other, and in particular the forward signal can be generated symmetrically to the backward signal with respect to a preferred plane of the respective individual hearing device, wherein the preferred plane is assigned to the frontal plane of the wearer preferably when wearing the hearing instrument. Aligning the first directional signal with the frontal direction of the wearer facilitates signal processing, as this takes into account the natural viewing direction of the wearer.

It is advantageous if the forward signals are each generated as a forward cardioid directional signal and the backward signals are each generated as a backward cardioid directional signal (anti-cardioid). A cardioid directional signal can be formed by superimposing the two input signals on each other with the acoustic propagation delay corresponding to the (spatial) distance of the input transducers. Depending on the sign of this propagation delay during the superposition, the direction of a maximum attenuation lies in the frontal direction (backward cardioid directional signal) or in the opposite direction (forward cardioid directional signal).

The direction of maximum sensitivity is opposite to the direction of maximum attenuation. This facilitates further signal processing, as such an intermediate signal is particularly suitable for adaptive directional microphony due to the maximum attenuation in or against the frontal direction. Furthermore, the omnidirectional signal can be represented or reproduced by a difference between the forward cardioid directional signal and the backward cardioid directional signal, so that the procedure can run on the level of the cardioid and anti-cardioid signals, and the first directional signal is only generated for the determination of the corresponding adaptive adaptation parameter.

The first and second directional signals are generated by means of adaptive directional microphones. In this way, it can be achieved in a particularly simple way that the directions in which the directional signals have the maximum attenuation coincide with a direction of a dominant sound source located in the rear half-space.

The binaural hearing instrument according to the invention has two signal-technically coupled individual hearing devices. Each of the individual hearing devices has a first input transducer for generating a first input signal from a sound signal of the environment and a second input transducer for generating a second input signal from a sound signal of the environment. The individual hearing devices further comprise a controller (i.e. a control unit) which is, for example, part of a signal processing unit.

In this case, the controller is generally set up—in terms of programming and/or circuitry—to carry out the method according to the invention described above. The controller is thus specifically set up to generate a forward signal and a backward signal from the respective input signals. The controller is further arranged to combine the respective forward and backward signal by means of a linear combination to a first directional signal, wherein the controller determines an adaptation parameter as a linear factor. The controller further compares the adaptation parameter with a stored threshold value and triggers a synchronization of the adaptation parameters of the two individual hearing devices if the value falls below the threshold value. The controller then generates a second alignment signal based on the respective synchronized alignment parameter. The second directional signal is output as an output or audio signal, for example, to an output transducer of the respective individual hearing device.

Thus, a particularly suitable binaural hearing instrument is realized. In particular, a hearing instrument with a binaural semi-synchronization of adaptation parameters of a monoaural adaptive directional microphone method is thus realized. The binaural hearing instrument according to the invention thus has improved directional signal processing, in particular in hearing situations without a dominant noise source.

In a preferred embodiment, the controller is formed, at least in its core, by a microcontroller with a processor and a data memory in which the functionality for carrying out the method according to the invention is implemented programmatically in the form of operating software (firmware), so that the method is carried out automatically-if necessary in interaction with an instrument user-when the operating software is executed in the microcontroller. Alternatively, within the scope of the invention, the controller can also be formed by a non-programmable electronic component, such as, for example, an application-specific integrated circuit (ASIC) or by an FPGA (field programmable gate array), in which the functionality for carrying out the method according to the invention is implemented by circuit-technical means.

Other features which are considered as characteristic for the invention are set forth in the appended claims.

Although the invention is illustrated and described herein as embodied in a method of operating a binaural hearing instrument, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is an illustration of a binaural hearing instrument with two individual hearing devices;

FIG. 2 is a block diagram showing the functional division of a method for operating the hearing instrument; and

FIGS. 3A to 4B are illustrations showing different directional characteristics of the hearing instrument.

Corresponding parts and sizes are always given the same reference signs in all figures.

### DETAILED DESCRIPTION OF THE INVENTION

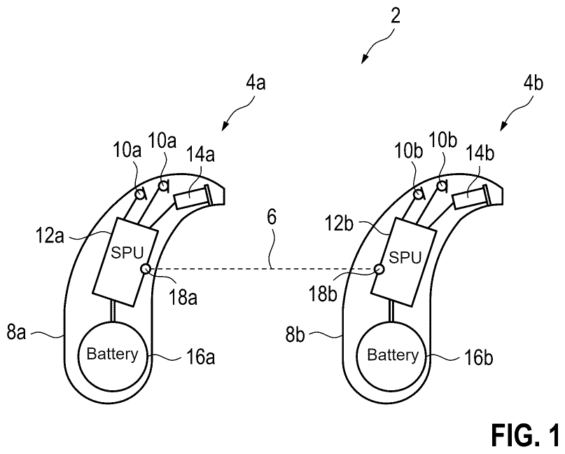

Referring now to the figures of the drawings in detail and first, particularly to FIG. 1 thereof, there is shown the basic structure of a binaural hearing instrument 2 according to the invention. The hearing instrument 2 is configured with two signal-coupled hearing aids or individual hearing devices 4a, 4b. The individual hearing devices 4a, 4b are exemplarily configured as behind-the-ear hearing aids (BTE). The individual hearing devices 4a, 4b are signal-coupled or can be coupled to each other by means of a wireless communication link 6.

The communication link 6 is, for example, an inductive coupling between the individual hearing devices 4a and 4b, alternatively, the communication link 6 can be configured, for example, as a radio link, in particular as a Bluetooth or RFID link, between the individual hearing devices 4a and 4b.

In the application state, the individual hearing device 4a is arranged, for example, on the left ear of the hearing instrument user, with the individual hearing device 4b being arranged accordingly on a right ear.

The structure of the individual hearing devices 4a, 4b is explained below by way of example using the individual hearing device 4a, whereby the explanations can also be applied mutatis mutandis to the individual hearing device 4b. The components of the single unit 4a are marked with the suffix “a”, whereas in the figures the corresponding components of the single unit 4b are marked with the corresponding suffix “b”.

As schematically shown in FIG. 1, the individual hearing device 4a contains a (device) housing 8a in which several microphones, also referred to as (acousto-electric) input transducers 10a, are installed. In the shown embodiment, the individual hearing devices 4a, 4b each have at least two input transducers 10a, 10b.

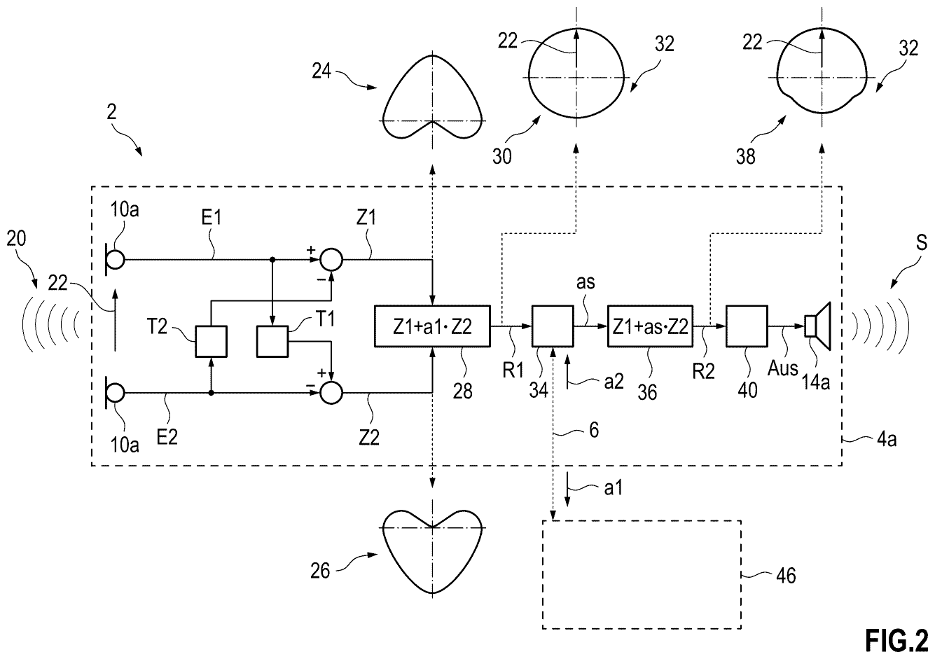

With the input transducers 10a, a sound or the acoustic signals in an environment of the hearing instrument 2 are picked up and converted into electrical, in particular multi-channel, input signals E1, E2 (FIG. 2). Preferably, the input signals E1, E2 have several frequency channels, for example 48 channels in the frequency range between 0 KHz and 28 KHz.

A signal processing unit 12a, which is also integrated in the housing 8a, processes the input signals E1, E2. An output signal Aus (FIG. 2) from the signal processing unit 12a is transmitted to an output transducer 14a, in particular to an electro-acoustic output transducer, which is configured as a loudspeaker or receiver, for example, which outputs an acoustic signal S (FIG. 2). In the case of the individual hearing device 4a, the acoustic signal is transmitted to the eardrum of a hearing system user, if necessary, via a sound tube or external earpiece not shown in more detail, which is fitted with an earmold inserted in the auditory canal. However, an electro-mechanical output transducer is also conceivable as a receiver, as in the case of a bone conduction receiver, for example.

The power supply of the individual hearing device 4a and in particular that of the signal processing unit 12a is provided by a battery 16a also integrated in the housing 8a.

The signal processing unit 12a is connected in terms of signals to a transmitting and receiving unit (transceiver) 18a. The transceiver 18a is used in particular for transmitting and receiving wireless signals by means of the communication link 6.

In the following, a method for operating the hearing instrument 2 is explained in more detail with reference to FIG. 2. The method is in particular a directional signal processing of the binaural hearing instrument 2, which is essentially implemented in a controller of the respective signal processing units 12a, 12b. The method is explained below for the signal processing of the individual hearing device 4a as an example. In the individual hearing device 4b, the procedure is carried out accordingly.

The two input transducers 10a pick up sound signals (noises, tones, speech, etc.) 20 from the environment during operation of the hearing instrument 2 and convert them into the multi-channel input signals E1, E2. One of the input transducers 10a (first input transducer) is arranged further forward with respect to a frontal direction 22 of the hearing instrument 2 (which is defined by the intended wearing during operation) compared to the other (second) input transducer 10a. The front input transducer 10a generates the first input signal E1, and the rear input transducer 10a generates the input signal E2.

The second input signal E2 is now delayed by a first delay parameter T2, and the thus delayed second input signal is subtracted from the first input signal E1 to produce a forward signal Z1. Similarly, the first input signal E1 is delayed by a second delay parameter T1, and the second input signal E2 is subtracted from the thus delayed first input signal to produce a backward signal Z2. The first delay parameter T1 and the second delay parameter T2 are given here, except for possible quantification errors during digitization, by the transit time, which corresponds exactly to the spatial sound path between the two input transducers 10a. Thus, the forward signal Z1 is given by a forward cardioid signal 24, and the backward signal Z2 by a backward cardioid signal 26 (i.e. an anti-cardioid).

By means of an adaptive directional microphony 28, a first directional signal R1 is now achieved from the forward signal Z1 and the backward signal Z2 by minimizing the signal energy of the signal Z1+a1×Z2 via a first adaptation parameter a1. The first directional signal R1 has a directional characteristic 30.

In the example shown, there is no dominant noise source in the sound signal 20, but a more diffuse noise situation or a transition phase between loud and quiet surroundings. The directional microphone 28 thus generates a directional signal R1 that does not form a pronounced notch to the side. The resulting directional signal 30 is a subcardioid, with attenuation in a rear half-space 32. In other words, the directional signal R1 is a subcardioid signal. This means that the first directivity parameter a1 has a value corresponding to a subcardioid. The first adaptation parameter a1 has a value range between −1 and 2, whereby the first adaptation parameter a1 is dimensioned between −1 and 0 in the case of a subcardioid.

The directional signal R1 is fed to a synchronization unit 34, which compares the first adaptation parameter a1 with a stored threshold value. The threshold value is dimensioned to 0, for example, so that a subcardioid directional characteristic 30 of the directional signal R1 is present if the synchronization unit 34 registers that the parameter value falls below the threshold value.

The synchronization units 34 of the individual hearing devices 4a, 4b are signal-technically coupled by means of the communication link 6. If the parameter value falls below the threshold value in at least one of the individual hearing devices 4a, 4b or the synchronization units 34, the adaptation parameter a1 of the individual hearing device 4a is transmitted to the individual hearing device 4b or its synchronization unit 34. Accordingly, the individual hearing device 4b transmits its first adaptation parameter a2 to the individual hearing device 4a or its synchronization unit 34. As a result, the first adaptation parameters a1, a2 of the first directional signals R1 generated by the individual hearing devices 4a, 4b are present in both individual hearing devices 4a, 4b or in their respective synchronization units 34.

The synchronization units 34 each determine a synchronized adaptation parameter as, so that after synchronization the same synchronized adaptation parameters as are present in both individual hearing devices 4a, 4b. Preferably, the synchronized adaptation parameter as is generated when both adaptation parameters a1, a2 are smaller than the threshold value.

Based on the synchronized adaptation parameter as, a second directional signal R2 is generated by means of an adaptive directional microphony 36. For this purpose, the forward and backward signals Z1, Z2 are linked or processed by means of the synchronized adaptation parameter a2. The resulting directional signal R2 has a subcardioid directional characteristic 38. In other words, the directional signal R2 is a subcardioid signal.

The directional signal R2 is then e.g. fed to a non-directional signal processing 40 of the signal processing unit 12a, which generates the output signal Aus for the output transducer 14a. The non-directional signal processing 40 comprises e.g. filtering and/or attenuation/amplification of one or more frequency channels of the directional signal R2.

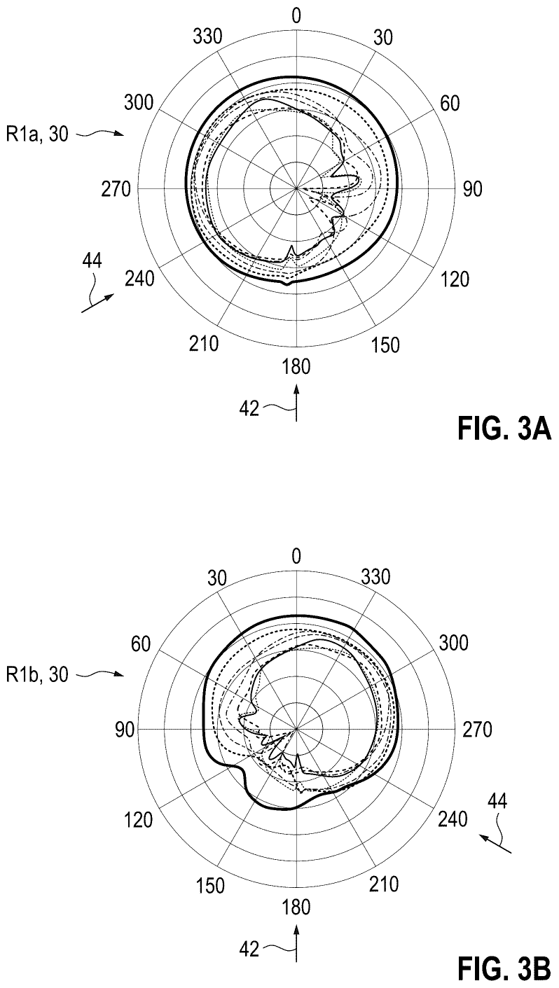

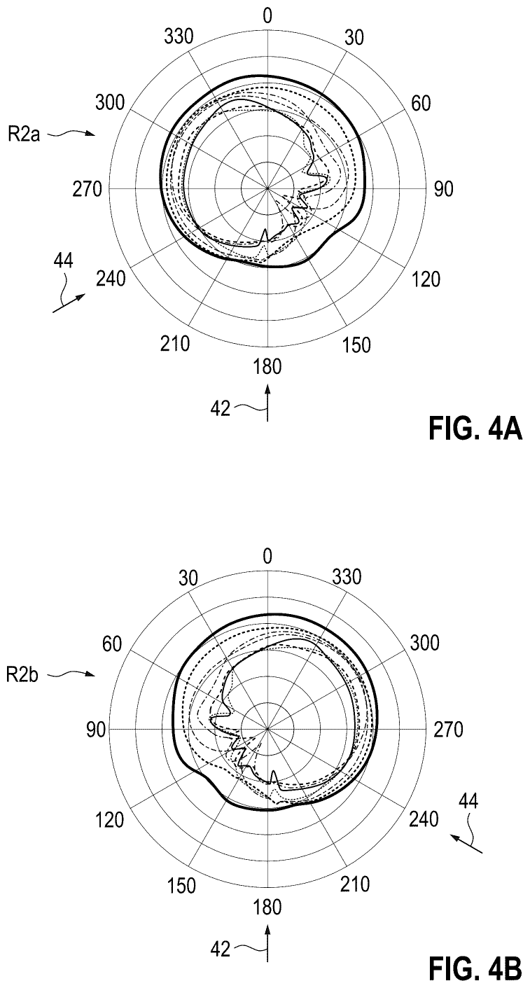

The synchronization of the adaptation parameters a1, a2 is explained in more detail below with reference to FIGS. 3A to 4B. FIGS. 3A to 4B each show horizontal directional diagrams for the directional signals R1, R2 in polar coordinates for visualizing the directional characteristics 30, 38. FIGS. 3A and 3B show the directional signal R1 for the individual hearing devices 4a and 4b, for example FIG. 3A shows the directional signal R1 for the individual hearing device 4a worn on the left ear and FIG. 3B shows the directional signal R1 for the individual hearing device 4b worn on the right ear. Accordingly, FIG. 4A shows the direction signal R2 for the individual hearing device 4a and FIG. 4B shows the direction signal R2 for the individual hearing device 4b.

The directional signals R1, R2 are multi-channel, with, for example, the directional characteristics 30, 38 for 7 different frequency channels shown in FIGS. 3A to 4B. In FIG. 3A to FIG. 4B, two arrows 42, 44 are further shown in each case. The arrow 42 points to the attenuation at 180° and the arrow 44 to the attenuation at ±120°.

In this embodiment example, the adaptation parameter a1 of the single device 4a has, for example, the parameter value a1=−0.5, where the adaptation parameter a2 of the single device 4b has the parameter value a2=−0.125. As a result, a combination of different adaptation parameters a1, a2 for the subcardioid signals is present, whereby the hearing instrument 2 would cause an asymmetric attenuation or attenuation of the sound signal 20. As can be seen in particular from the arrows 42, 44, the resulting amplification or attenuation in the subcardioid range of the directional signal R1 is different.

By synchronizing the adaptation parameters a1, a2 only for the subcardioid range between the left and right individual hearing devices 4a, 4b, mislocalization is avoided. The attenuation to the rear half-space 32 is thus the same for both ears, and a noise source from 180° would be correctly perceived in the center of the sound field.

In one conceivable embodiment, a maximum or minimum value is used as the synchronization mechanism. This means that either the adaptation parameter a1 of the single unit 4a or the adaptation parameter a2 of the single unit 4b is used as the synchronized adaptation parameter as, whichever is larger (or smaller). Expressed as a formula, as =max (a1, a2) or as =min (a1, a2).

In an alternative embodiment, the alignment parameters a1, a2 are evaluated as a function of a respective signal level of the first alignment signals R1. A signal level for the first directional signals R1 is determined and the adaptation parameters a1, a2 are weighted for synchronization on the basis of this level. Expressed as a formula, as =f1 (R1)*a1+f2 (R1)*a2, where f1 and f2 are corresponding weighting functions depending on the respective directional signal R1 or its signal level.

In the example shown in FIGS. 4A and 4B, the synchronized adaptation parameter as is the geometric mean of a1 and a2, i.e. as =√(a1×a2). Specifically, the adaptation parameter as in the example is as =−0.25. The synchronized adaptation parameter as leads to a symmetrical attenuation/amplification in the resulting directional signal R2 with the same 180° direction. As can be seen in particular from the arrows 42, 44, the resulting amplification or attenuation is the same in the subcardioid range of the directional signal R2. Alternatively, an arithmetic means is used to synchronize the adaptation parameters a1, a2.

The claimed invention is not limited to the embodiments described above. Rather, other variants of the invention may also be derived therefrom by the skilled person within the scope of the disclosed claims without departing from the subject-matter of the claimed invention. In particular, all the individual features described in connection with the various embodiments can also be combined in other ways within the scope of the disclosed claims without departing from the subject-matter of the claimed invention.

The following is a summary list of reference numerals and the corresponding structure used in the above description of the invention:
2 Hearing instrument
4a, 4b Single unit
6 Communication link
8a, 8b Housing
10a, 10b Input transformer
12a, 12b Signal processing unit
14a, 14b Output converter
16a, 16b Battery
18a, 18b Transceiver
20 Sound signal
22 Frontal direction
24 Cardioid signal
26 Cardioid signal
28 Directional microphony
30 Directional characteristic
32 Half-space
34 Synchronization unit
36 Directional microphony
38 Directional characteristic
40 Signal processing
42 Arrows
44 Arrows
E1, E2 Input signal
Aus Output signal
S Signal
T1, T2 Delay parameter
Z1 Forward signal
Z2 Backward signal
R1 Directional signal
a1, a2 Directive parameter
as Directive parameter
R2 Directional signal

1. A method for operating a binaural hearing instrument having two signal-coupled individual hearing devices, wherein in each of the individual hearing devices performing the method steps of:
a) generating a first input signal from a sound signal of an environment by a first input transducer of each of the individual hearing devices;
b) generating a second input signal from the sound signal of the environment by a second input transducer of each of the individual hearing devices;
c) generating a forward signal and a backward signal from the first input signal and from the second input signal;
d) determining a first adaptation parameter as a linear factor of a linear combination of the forward signal and the backward signal, in that a first directional signal resulting from the linear combination has an attenuation in one direction;
e) comparing the first adaptation parameter with a stored threshold value;
f) synchronizing the first adaptation parameter of the individual hearing devices with one another, if at least one said first adaptation parameter of the individual hearing devices falls below the stored threshold value;
f1) generating a second directional signal in each case based on synchronized adaptation parameters; and
f2) generating an output signal in each of the individual hearing devices in each case based on the second directional signal.

2. The method according to claim 1, which further comprises synchronizing said first adaptation parameter of the individual hearing devices with one another if the first adaptation parameter of both of the individual hearing devices fall below the threshold value.

3. The method according to claim 1, which further comprises generating the second directional signal in each of the individual hearing devices by the linear combination of the forward signal and the backward signal with the synchronized adaptation parameter as the linear factor.

4. The method according to claim 1, wherein the stored threshold value characterizes a parameter range at which the first directional signal has a subcardiod directional characteristic.

5. Method according to claim 1, wherein the first adaptation parameter of each of the individual hearing devices has a range of values between −1 and 2, and in that a value 0 is used as the stored threshold value.

6. The method according to claim 1, wherein a maximum or minimum value of the first adaptation parameter is used for synchronization of the first adaptation parameter.

7. The method according to claim 1, wherein the first adaptation parameter for synchronization is weighted as a function of a respective signal level of the first directional signal.

8. The method according to claim 1, wherein the forward signals are each generated based of a time-delayed superimposition of the first input signal with the second input signal implemented by means of a first delay parameter, and/or in that the backward signals are each generated on a basis of a time-delayed superimposition of the first input signal with the second input signal implemented by means of a second delay parameter.

9. The method according to claim 1, wherein the forward signal of each of the individual hearing devices is generated as forward a cardioid directional signal, and in that the backward signal of each of the individual hearing devices is generated as a backward cardioid directional signal.

10. A binaural hearing instrument, comprising:
two signal-technically coupled individual hearing devices which in each case having a first input transducer for generating a first input signal from a sound signal of an environment and with in each case a second input transducer for generating a second input signal from the sound signal of the environment and with in each case a controller configured to carry out the method according to claim 1.
